(19) United States
(12) Patent Application Publication
(10) Pub. No.: US 2006/0062973 A1
(43) Pub. Date: Mar. 23, 2006

(54) Fibre reinforced composite component

(75) Inventor: Robert Samuel Wilson, Belfast (GB)

Correspondence Address: FULBRIGHT AND JAWORSKI LLP, 555 S. FLOWER STREET, 41ST FLOOR, LOS ANGELES, CA, 90071, US

(73) Assignee: SHORT BROTHERS PLC

(21) Appl. No.: 11/007,796

(22) Filed: Dec. 7, 2004

Related U.S. Application Data
(63) Continuation of application No. PCT/GB03/02458, filed on Jun. 7, 2003.

(30) Foreign Application Priority Data
Jun. 7, 2002 (GB) GB 0213161.3

(51) Int. Cl. B32B 3/20

(52) U.S. Cl. 428/188; 428/166

(57) ABSTRACT

A fibre reinforced composite component is provided having cured fibre reinforced wall elements which extend in side by side relation along the length or width of the component between the front face and the rear face and which are formed by setting up an assembly of mandrels in side by side disposition, which are clad with a reinforcing fibre material, curing the material after resin impregnation to form the wall elements, and removing the mandrels to form cells bounded or partly bounded by the wall elements.

This is a continuation application of International Application PCT/GB03/02458, having an international filing date of Jun. 7, 2003, now abandoned, which claims priority to UK Application GB 0213161.3, having a filing date of Jun. 7, 2002, for which priority under 35 U.S.C. 119 is claimed.

### BACKGROUND OF THE INVENTION

The present invention relates to a fibre reinforced composite component and its manufacture.

### SUMMARY OF THE INVENTION

Fibre reinforced composite components are particularly suitable for forming structural panels used in many industries including the aerospace industry. Typical examples of such panel structures are wing-to-fuselage fairings, stiffened skins of primary structures such as fuselages and pressure bulkheads, and turbofan engine nacelle fan cowl doors where extensive use has been made of honeycomb sandwich panels which are used to stiffen composite secondary structures.

The principal drawbacks that have been encountered with honeycomb sandwich panels are that (i) they are expensive to produce and (ii) they have a low tolerance to damage.

The high costs are attributed to (i) the cost of producing the honeycomb core, (ii) the cost of machining and forming the panels, and (iii) the cost of manufacturing the required autoclaves, which are also labour intensive and utilise high cost raw materials such as pre-impregnated carbon fibre fabrics (prepreg).

Because of their structural efficiency, honeycomb core stiffened panels have inherently thin skins, which can be easily damaged, are prone to water ingress and incur complex costly repairs.

The repair costs are such an important factor that airlines are reportedly considering a return to heavier metallic panel structures. It has been proposed, for example, to remove honeycomb sandwich panel nacelle doors and replace them with heavier aluminum doors. There is the additional problem that the poor in-service durability of honeycomb stiffened composite panel structures causes lost revenue when damage is sufficiently serious to prevent operational use of an aircraft.

It is an object of the present invention to provide a fibre reinforced composite component which does not have or which does not have to the same extent the drawbacks of high cost and low damage tolerance of the honeycomb sandwich panel construction.

According to a first aspect of the present invention there is provided a fibre reinforced composite component having a front face and a rear face and a cell defining wall structure located between the front face and the rear face, characterised in that the structure has cured fibre reinforced wall elements which extend in side by side relation along the length or width of the component between the front face and the rear face and which are formed by setting up an assembly of mandrels in side by side disposition, which are clad with a reinforcing fibre material, curing the material after resin impregnation to form the wall elements, and removing the mandrels to form cells bounded or partly bounded by the wall elements.

In an embodiment of the invention hereinafter to be described the reinforcing fibre material comprises a reinforcing fibre braid applied to the mandrels prior to assembly of the mandrels. The clad mandrels are arranged in spaced relation along the length or width of the component or in juxtaposition along the length or width of the component.

In an embodiment of the invention hereinafter to be described the assembly of clad mandrels comprises a first sub-assembly of clad mandrels extending along the length of the component and a second sub-assembly of clad mandrels superposed on the first sub-assembly of clad mandrels and extending along the width of the component.

In an embodiment of the invention hereinafter to be described the clad mandrels are of multi-sided cross-section, and the cured wall elements are formed along opposing side faces of the mandrels. The clad mandrels may be of rectangular or square cross-section and have two parallel opposing side faces and parallel base and top faces. The cured wall elements are then formed along the parallel opposing side faces and the base and top faces are at the front and rear faces of the component.

In an alternative embodiment of the invention hereafter to be described the clad mandrels are of triangular cross-section and have two inclined opposing side faces and a base face, and the cured wall elements are formed along the inclined opposing side faces of the mandrels with the base face at the front face or the rear face of the component.

In yet another embodiment of the invention hereinafter to be described the clad mandrels are of trapezoidal cross-section and have two inclined opposing side faces, a base face and a top face, and the cured wall elements are formed along the inclined opposing side faces of the mandrels and the base and top faces are at the front and rear faces of the component.

The reinforcing fibre material may include a stiffener element at one or more of the side faces of the clad mandrels and/or at the faces of the clad mandrels at the front and/or rear face of the component.

In a specific embodiment of the invention hereinafter to be described the fibre reinforcing material extends fully around the mandrels and the component includes a front skin adjacent to the front face of the component and a rear skin adjacent to the rear face of the component.

In an embodiment of the invention hereinafter to be described the front and rear skins extend along the length and width of the component and provide support for and receive support from the cured fibre reinforced wall elements.

According to a second aspect of the present invention there is provided a method of manufacturing a fibre reinforced composite component having a front face and a rear face and a cell defining wall structure between the front face and the rear face, characterised in that the method comprises the steps of arranging a plurality of mandrels in side by side disposition and clad with a reinforcing fibre material, curing the material after resin impregnation to form from the material wall elements of the cell defining wall structure which extend in side by side relation along the width or length of the component between the front face and the rear face of the component, and removing the mandrels to form cells bounded by the wall elements.

In Applicants=prior published Patent Application GB2316036A there is described a process for forming a fibre reinforced resin composite component. The process, hereinafter referred to as a resin transfer infusion process (RTI) comprises:

(I) in a first processing stage the steps of laying up a reinforcing fibre assembly on a hard tool face, overlying the reinforcing fibre lay up assembly with an elastomeric bagging blanket such that the elastomeric bagging blanket cooperates with the hard tool face so as to form therewith a sealed enclosure which encloses the reinforcing fibre lay up assembly, injecting a liquid resin into the sealed enclosure and controlling the viscosity of the liquid resin so that it is maintained in a liquid state thereby to form a liquid resin/reinforcing fibre lay assembly system in the sealed enclosure;

(II) in a second processing stage the step of controlling the viscosity of the liquid resin in the sealed enclosure so that it is maintained at a first viscosity value which enables the liquid resin to impregnate the reinforcing fibre lay up assembly; and

(III) in a third processing stage the step of controlling the viscosity of the liquid resin in the sealed enclosure so that it is increased from the first viscosity value to bring the liquid resin to a cured state to form the fibre reinforced resin composite component.

In the process disclosed in GB2316036A, hereinafter referred to as an elevated temperature resin transfer infusion process, in the first, second and third processing stages the temperature in the sealed enclosure is controlled to control the viscosity of the liquid resin. Preferably, vacuum pressure is applied to the sealed enclosure to draw the liquid resin into the sealed enclosure.

The resin transfer infusion process makes it unnecessary to utilise prepreg elements in the component being manufactured and makes it advantageous for use in forming components which would otherwise be difficult to manufacture using traditional resin transfer mould equipment in which use is made of prepreg elements and involves the complications which arise out of the use of them.

In particular the resin transfer infusion process is suitable for manufacturing components having multiple layers, 2D fabrics or uniweave as well as other forms of dry preform including 3D weaves, 3D braids, secondary stitched 2D plies and multi-axis non-crimp fabrics.

In an embodiment of the invention according to its first or second aspect the steps of resin impregnation and the curing of the impregnated material are carried out in a process in which resin is infused into the surface of a dry preform of the reinforcing fibre material at an elevated temperature. Preferably, the process is an elevated temperature resin transfer infusion process and preferably the fibre reinforced composite component is produced by the process without the use of pre-impregnated elements for the component.

### BRIEF DESCRIPTION OF THE DRAWINGS

Embodiments of the invention will now be described by way of example with reference to the accompanying drawings in which:

FIG. 1 is a perspective view of a panel component according to the invention,

FIGS. 2 to 5 are perspective views of mandrels used in the manufacture of the panel component of FIG. 1,

FIG. 6 is a perspective view of part of a braided mandrel,

FIG. 7 is a side view of a circular braiding machine of the kind for use in cladding the mandrels with braided material,

FIG. 8 is a schematic diagram of resin transfer infusion equipment for producing the panel component of FIG. 1,

FIGS. 9 to 13 are perspective views a part of the equipment shown in FIG. 8 with laid up elements of the panel components being manufactured,

FIG. 14 is an exploded view of the panel component shown in FIG. 1,

FIGS. 15(1) to 15(9) and 16(10) to 16(14) are schematic cross-sections of different panel components constructed according to the invention,

FIGS. 17a and 17b are perspective views of an aircraft illustrating fairing panels which can be constructed in accordance with the invention,

FIG. 18 is a sectional scrap view of a part of a hinged fan cowl door showing a conventional honeycomb panel,

FIG. 19 is a view of the panel shown in FIG. 18 with a high density honeycomb panel,

FIG. 20 is a sectional view of the panel of FIG. 18 showing a modification to strengthen the panel,

FIG. 21 is a sectional view of part of a panel component constructed according to the present invention,

FIG. 22 is a schematic perspective view of two connectable panel component sub-assemblies constructed according to the invention,

FIG. 23 is a schematic sectional view of the panel component sub-assemblies of FIG. 21, connected together to form a panel component according to the invention, and

FIG. 24 is a sectional view of the panel component of FIG. 22 as a hinged panel component.

### DETAILED DESCRIPTION OF THE PREFERRED EMBODIMENTS

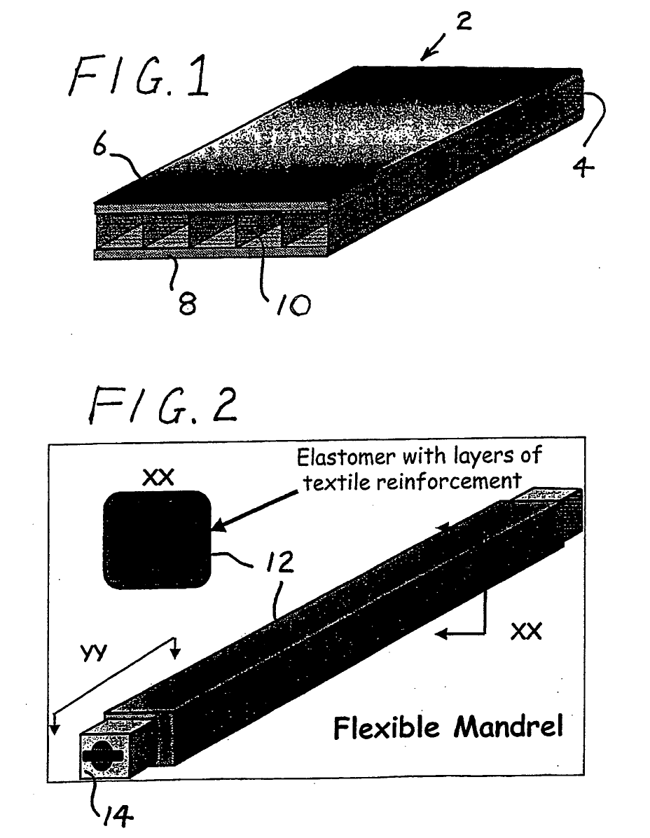

Referring to FIG. 1, a fibre reinforced composite panel component 2 according to the invention comprises a cell defining wall structure 4 located between front and rear skins 6 and 8. The wall structure 4 is in the form of cured fibre reinforced wall elements 10 which extend in side by side relation along the length of the component.

The following materials are suitable for producing both the wall structure 4 and the skins 6 and 8:

(i) Advanced composite materials.

(ii) Dry fabrics with multiple layers of uni-directional fibres stitched together.

(iii) Non-crimp fabrics (NCF) which utilise heavy weight tows.

In particular the following materials may be considered for both the wall structure 4 and the skins 6 and 8:

(i) Heavy uni-directional non-crimp fabric.

(ii) Biaxial non-crimp fabric.

(iii) Uni-weaves and 2D weaves (high tow count).

(iv) 2D braids.

(v) Triaxial braids, although these braids could have drape problems.

The fibres forming the above fabrics include aerospace fibres (HM, HS and IM) as well as commercial fibre T700, glass fibre or Kevlar which is more cost effective than aerospace fibre.

The cell defining wall structure 4 is formed by cladding an assembly of mandrels with a reinforcing fibre material. The material is then cured under resin impregnation to produce cured composite wall elements forming the walls of the cell defining wall structure, and the mandrels are then removed to form cells bounded by these wall elements.

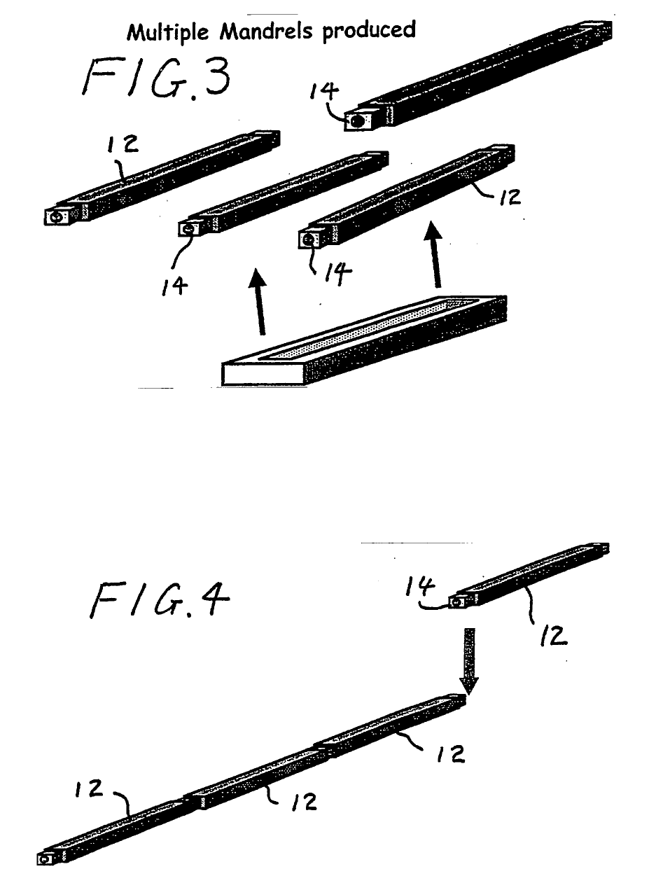

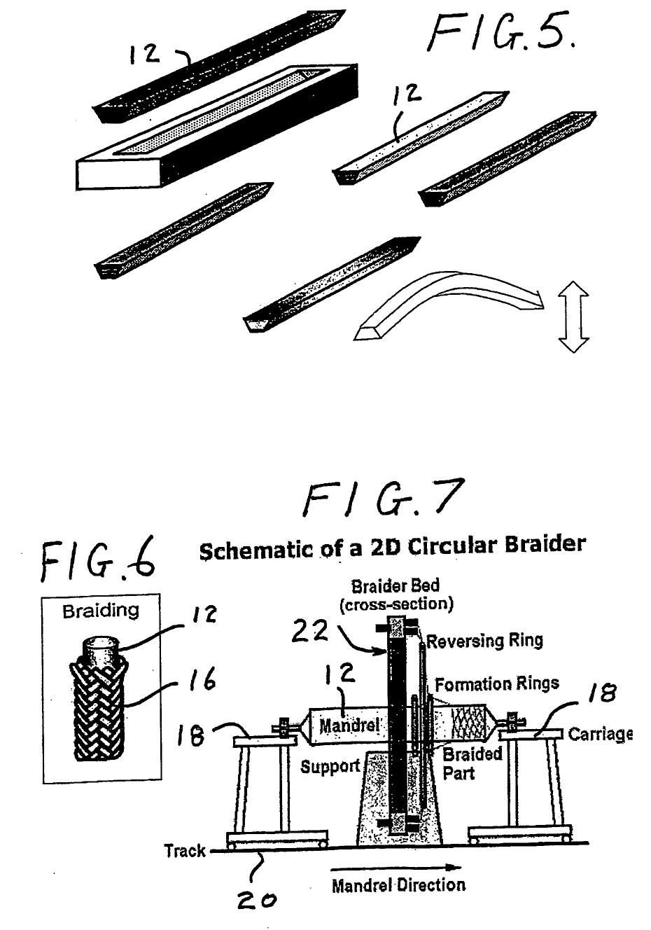

Referring to FIGS. 2 to 5 mandrels 12 are constructed of elastomeric material with layers of fibre reinforcement to restrict the coefficient of expansion in both the longitudinal and transverse directions.

Triangular or trapezoidal cross-section mandrels have the extra geometrical advantage insofar that some of the expansion in the principal expansion (contraction) direction normal to the plane of the outer mould line is transferred at right angles to the axis of the mandrels thereby facilitating mandrel release on cool down. It is however found that some contraction in this plane is still required at the mandrel base.

Some of the illustrated mandrels 12 have simple connect and disconnect joints 14 at their ends to enable the mandrels to be joined together and disconnected when required.

The following are suitable materials from which the mandrels may be manufactured:

(i) Fluoro-elastomer reinforced with aramid fibres.

(ii) Silicone rubber reinforced with glass fibres.

(iii) Poly-acrylic rubber with graphite/epoxy prepreg reinforcement.

(iv) Where geometry permites e.g. on Flat Rib webs or Floor panels, high expansions metallic mandrels may be used such as Aluminium Alloy.

(v) In places where there may not be access to remove the mandrels “fly away” (Mandrels left in the structure) may be used. These mandrels may also contribute to the structure strength or stiffiness. Suitable materials include closed cell light weight foams e.g. polymethacryimide or sealed cell honeycomb core.

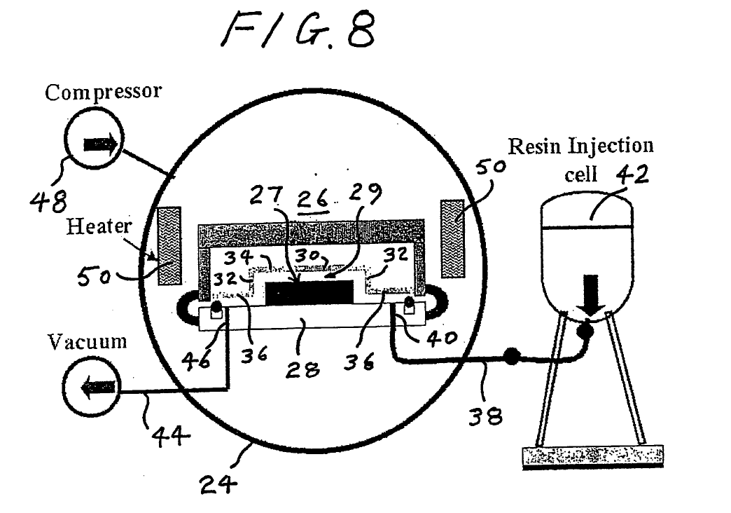

Referring to FIGS. 6 and 7 each mandrel 12 is braided with a reinforcing fibre braid 16 constituting the reinforcing fibre material.

The mandrel 12 is held between two carriages 18 which run along a track 20 so that the mandrel 12 is passed through a braider bed 22 which braids the material onto the mandrel 12.

A low pressure resin transfer moulding (RTM) equipment using a resin transfer infusion process (RTI) for producing a fibre reinforced composite panel of the invention is shown in FIG. 8 and fully described in GB2316036A.

The mould 26 has a hard base 28 having a lay up region on which the elements of a composite panel are laid up as an assembly 27. An elastomeric bagging blanket 30 extends over the composite panel assembly 27 and sealingly cooperates with the hard base 28 at its outer peripheral edges to form a sealed enclosure 29 which encloses the composite panel assembly 27.

Typical elastomers for the blanket 30 include polyacrylic fluoro-elastomer or silicone, i.e. elastomers having good vacuum integrity.

The material of the bagging blanket 30 is selected to provide the blanket with a “soft” area 32 which enables the blanket to expand, and avoids the need for providing expansion folds or tucks to allow the blanket to expand.

The preferred material for combination with the elastomer to form the soft area 32 is a dry knit, for example of glass fibres. A dry knit bonded or mechanically keyed to the surface of the elastomer or encapsulated within the elastomer.

The blanket 30 also includes “semi-stiff” areas 34, 36. The first semi-stiff area 34 forms the central region of the blanket 30 which registers with the fibre reinforced composite lay-up assembly 27 while the second semi-stiff area 36 forms the outer peripheral area of the blanket 30 which sealingly cooperates with the hard base 28. Conveniently, the semi-stiff area 34 contains as the elastomer reinforcement a prepreg fibre assembly having a coefficient of thermal expansion which is compatible with that of the fibre reinforced composite component to be formed thereby facilitating mould release.

The equipment further comprises a liquid resin supply line 38 which at one end thereof is connected to a liquid resin inlet port 40 in the lay up region of the hard base 28, and which at its opposite end is connected to a liquid resin supply 42. In addition, the equipment also includes a vacuum supply line 44 which at one end thereof is connected to a vacuum outlet port 46 in the lay up region, and which at the opposite end thereof is connected to vacuum generation means (not shown) for applying a vacuum pressure to the sealed lay up region.

The application of vacuum pressure to the sealed enclosure causes liquid resin to be drawn or injected into the sealed enclosure 29 from the liquid supply 42 to form a liquid resin/reinforcing fibre lay-up assembly system in the sealed enclosure 29. This injection of liquid resin into the sealed enclosure can also be assisted by applying positive pressure to the liquid resin in the liquid resin supply 42. Application of vacuum pressure to the sealed enclosure 29 further acts to prevent air becoming trapped in the liquid resin/reinforcing fibre lay-up assembly system.

The application of vacuum pressure in the sealed enclosure through the vacuum outlet port 46 results in liquid resin being drawn into the lay-up region and impregnating the reinforcing fibre component lay-up assembly 27.

The mould 26 is located in an autoclave 24 to control the temperature in the sealed enclosure so that the viscosity of the liquid resin is maintained at a reduced value which allows wet-out of the reinforcing fibre lay up assembly.

After completion of the liquid resin injection stage the autoclave 24 is used to apply an external pressure to the blanket 30 to cause the blanket 30 to apply a consolidating force to the liquid resin/reinforcing fibre lay up assembly system in the sealed enclosure 29 while maintaining control of the temperature in the sealed enclosure to keep the liquid resin at a reduced viscosity so as to enable full impregnation of the reinforcing fibre lay up assembly with liquid resin. For this consolidation stage the vacuum pressure is withdrawn and the liquid resin inlet port 40 is used for ejecting excess liquid resin from the sealed enclosure 29 to a resin dump (not shown) under the action of a consolidating force applied to the liquid resin/reinforcing fibre lay up assembly by the blanket 30.

After the consolidation stage has been completed the external pressure applied to the blanket and the temperature in the sealed enclosure 29 are controlled by a compressor 48 and heaters 50 to cure the liquid resin impregnated into the reinforcing fibre lay up assembly 27 and thereby to form a fibre reinforced resin composite component.

FIGS. 9 to 13 are perspective views showing successive stages in building up the composite component lay up assembly 27 on the hard base 28.

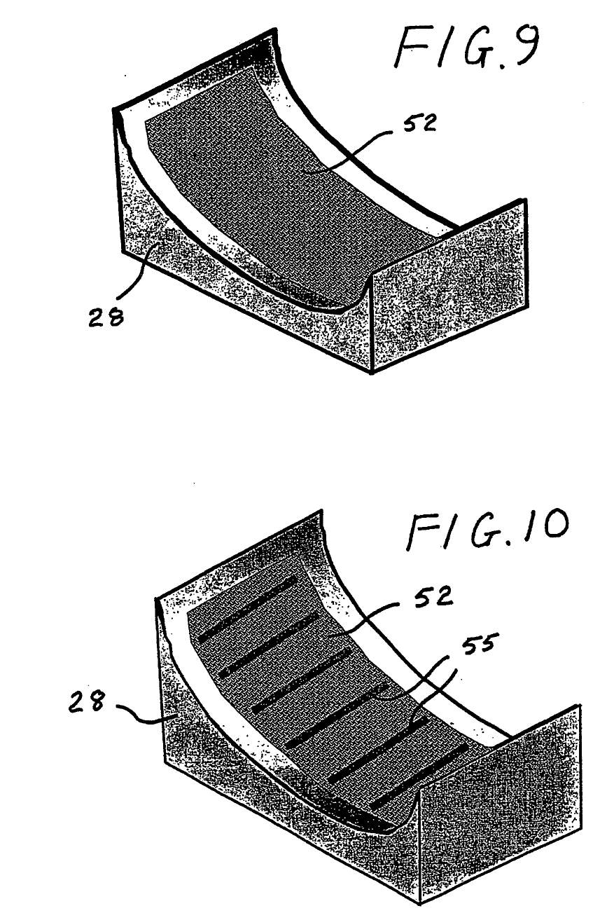

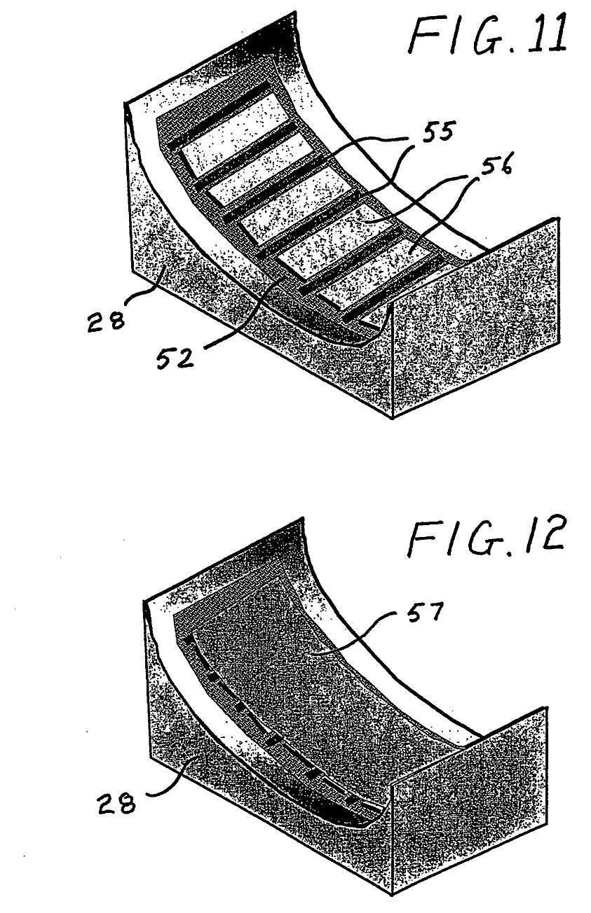

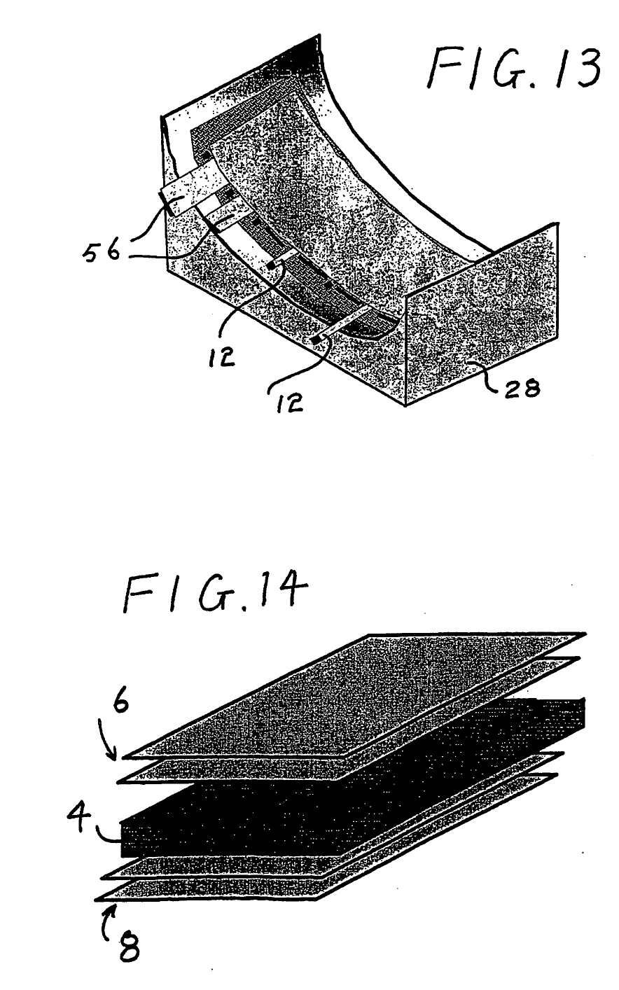

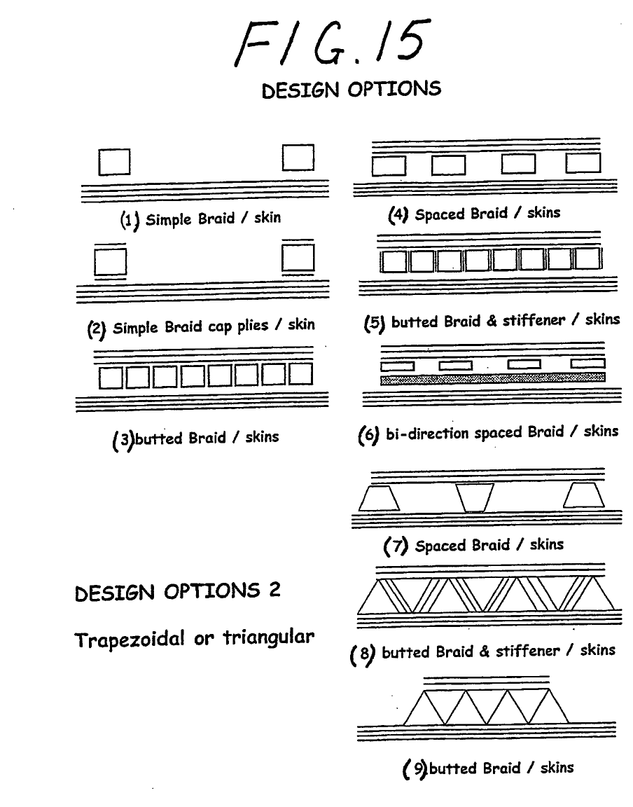

As shown in FIG. 9, a preform front skin 52 of the component is first laid on a hard base 28 of the mould employed in the equipment shown in FIG. 8. As shown in FIG. 10 braided mandrels 55 are then laid across the width of the front skin 52 at spaced locations thereof. In FIG. 11, unbraided mandrels 56 are placed on the skin 52 between the braided mandrels 55. In FIG. 12, the preform rear skin 57 of the component is laid on the front skin 52 and over the clad mandrels 55 and the unclad mandrels 56. The assembly is then impregnated and cured as hereinbefore described in the equipment shown in FIG. 8. FIG. 13 illustrates the impregnated and cured composite component assembly 27 ready for the mandrels 55 and 56 to be removed.

The resin transfer infusion process for manufacturing the composite component of the invention has the following advantages:

(i) Reduced weight due to the use of advanced composite materials.

(ii) The use of low cost materials such as dry fabrics with multiple layers of uni-directional fibres stitched together (non-crimp fabrics NCF) which utilise heavy weight tows.

(iii) Multiple layers of fabric can be used in one operation thereby reducing lay-up time.

(iv) No prepreg out-time problems. Large prepreg structures usually have to be laid up and cured in ten days thereby taking up autoclave operation time.

(v) No prepreging costs (the processing, storage, expendable material cost of prepreg can be high).

(vi) Potentially better thickness tolerances over prepreg.

(vii) Utilises existing autoclave composite manufacturing infrastructure.

The use of autoclaves in conjunction with resin transfer moulding has the following advantages:

(i) Flexible for use over a range of component sizes (and multiples).

(ii) Efficient operation with controlled heat-up and cool-down (no contamination).

(iii) Simplified tooling (no bending moments, no press requirements).

(iv) No internal stress problems; all stripping is simple and the autoclave pressure consolidates the material and holds it all closed.

(v) No health and safety concerns.

(vi) Fueling costs are minimised, and the apparatus is more simple because one side is semi-flexible.

(vii) Flexible for design changes.

FIGS. 14 to 16 illustrate different combinations of braid and skin component parts forming the composite component of the invention.

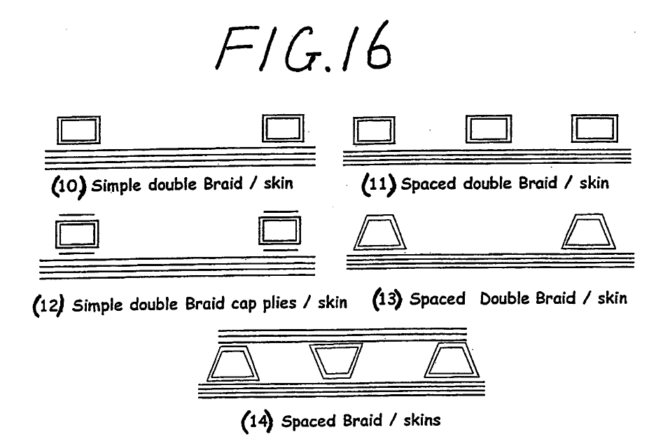

FIG. 14 is an exploded view of a composite panel, cross-section of which in a variety of different forms are shown in FIGS. 15 and 16, with a braided cellular core 4 and multi-ply front and rear skins 6 and 8.

FIG. 15(1) to FIG. 15(6) illustrate panel assemblies with square or rectangular cross-section tubular braids. The braids in FIG. 15(2) have cap plies and the braids in FIG. 15(5) are butted and have stiffeners between adjacent braids.

FIG. 15(7) to FIG. 15(9) illustrate triangular and trapezoidal single braids between skins with FIG. 15(8) showing stiffeners between adjacent butted triangular braids.

FIGS. 16(10) to (14) illustrate rectangular and trapezoidal tubular double braids and skins, with FIG. 16(12) showing braids with cap plies. FIG. 16(13) shows a typical design for reinforcing a fan cowl door. In this case the stiffeners may form a grid with braided trapezoidal stiffeners intercepting each other at right angles. In this case it may not be possible to remove all the mandrels and “fly away” foam mandrels may be used.

It is not possible to provide stiffness or rigidity at right angles to the axis of the braid unless it is done by end pieces. These end pieces can be co-injected and then cured. Stiffness or rigidity can be provided by using triangular or trapezoidal sections of braid which will give shear strength in structures where this is required.

Uni-directional (UD) non-crimp fabric provides characteristics of UD tape with the draping quality of a weave together with enhanced damage tolerance over UD. The thicker ply capacity will also reduce lay-up time.

Furthermore the use of braiding will substantially reduce stiffener lay-up time.

Important advantages of using resin transfer infusion are lower raw material costs, reduced lay-up time and the feature that the expansion, due to the differential expansion of the mandrels during heat-up is minimised (34□C instead of the 154□C in prepreg). Where this differential is needed during cool down to facilitate mandrel release it is maximised over 154□C. In addition the flexible mould used with RTI allows expansion normal to the mould surface which is an advantage.

Bonding strength of the cured braiding to the skin is expected to be considerably better than that of the honeycomb skin, and the cured braiding construction of the invention provides shear strength both along and at right angles to the axis of the braid.

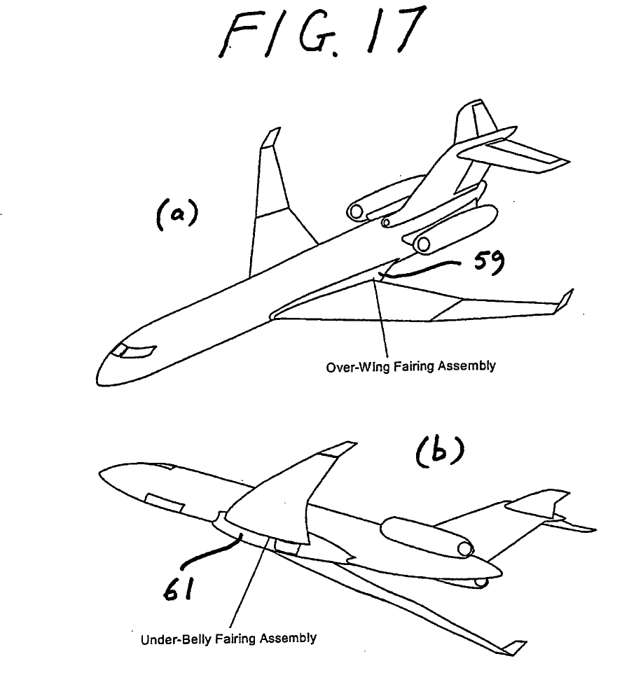

Fibre reinforced composite components of the invention are particularly suitable for use in the aerospace industry, and typical structures shown in FIGS. 17(a) and 17(b) include over-wing fairing assemblies 59 and under-belly assemblies 61.

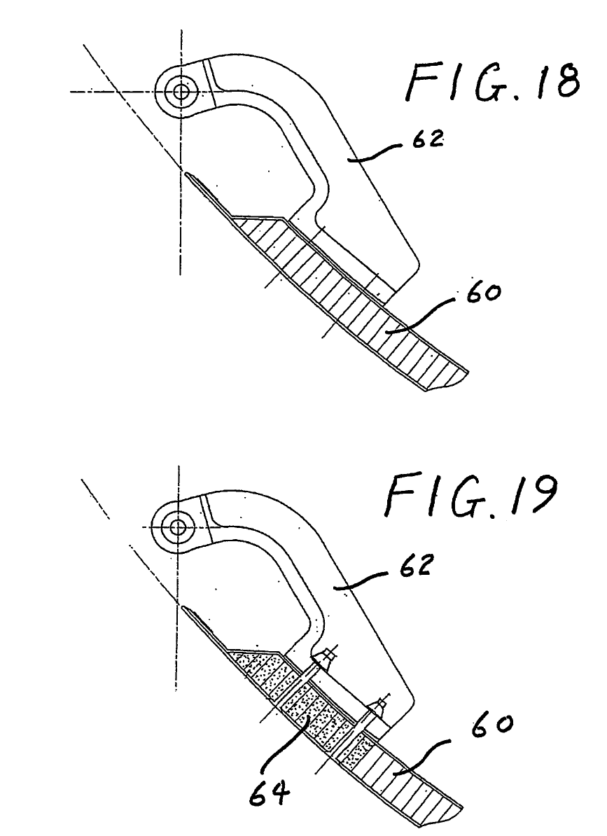

In FIG. 18, a panel 60 having the known honeycomb cell structure is mounted on a hinge 62 for use as a fan cowl door. In FIG. 19 the panel 60 is strengthened in known manner by using a potting compound 64 in the honeycomb cell structure, or the panel may have a high density honeycomb cell structure.

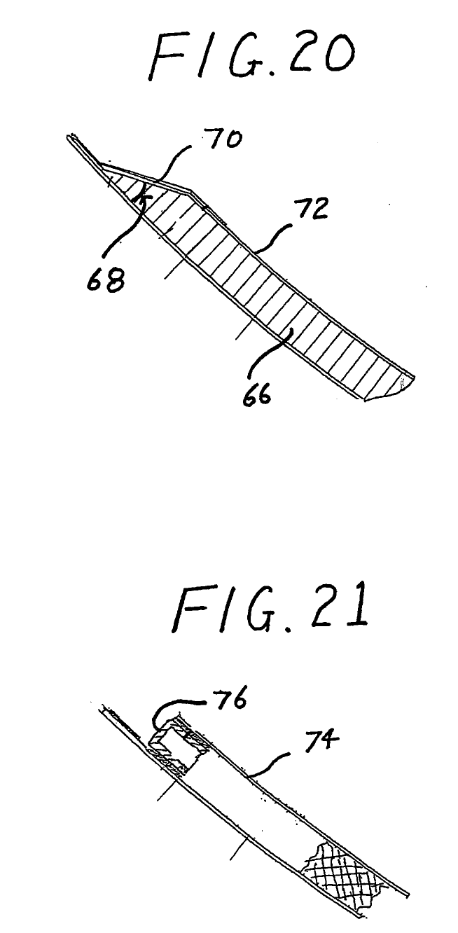

In FIG. 20 with the known honeycomb cell structure 66 it will be seen that the angle of the ramp 68 has to be decreased in some cases in order to prevent core collapse and extra plies 70 are required on the skin 72 to compensate for loss of stiffness.

In contrast and as shown in FIG. 21 with the panel construction of the invention a ramp is not required so that the skin 74 can be brought closer to the edge of the panel. If desired closing end caps 76 maybe fastened to the ends of the wall elements.

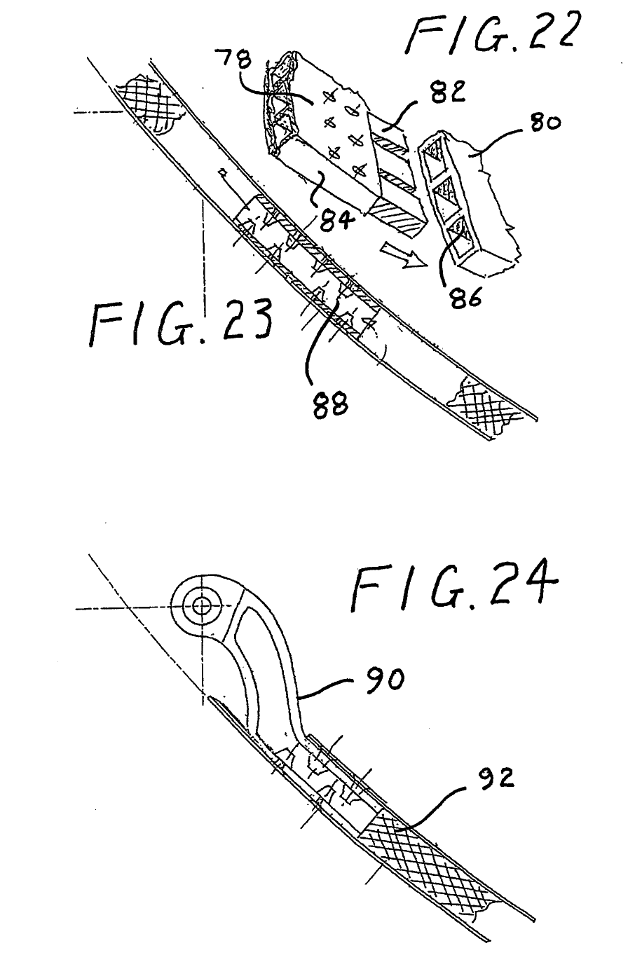

FIG. 22 illustrates two panels 78 and 80 which can be joined without loss of access from one panel to another. No potting compound or exterior joining plates are required. The wall elements 82 of panel 78 project at one end from the outer skin 84 of the panel. These wall elements are dimensioned to make a tight push fit in the wall elements 86 of the other panel 80.

FIG. 23 illustrates part of a panel of the invention showing how the wall elements can be cut away at the region 88 to provide access for systems such as air conditioning which can be made available inside the braided channels and used to advantage in fuselage skins and floor panels, in contrast to honeycomb structures which offer no such facility.

In FIG. 24 a hinge member 90 is fitted into a cell structure 92 of a panel of the invention thereby providing an efficient connection, saving weight and not requiring a potting compound or long thick fasteners.

The components according to the invention could potentially be used to produce a composite fuselage which would have the advantage of increasing cabin area while reducing costs both in terms of raw material, assembly and the elimination of fasteners and honeycomb core components.

Furthermore, in honeycomb core stiffened panels there is an inherent risk of poor honeycomb to skin bond whereas in the process according to the invention the braid bond area is much larger and integral to the skin and in addition the co-inject/bond process significantly reduces any contamination risk.

The invention in one of its aspects involves the use of Resin Transfer Infusion (RTI) technology primarily developed for large thick primary composite structures and applying it to produce a fibre reinforced composite component of novel and inventive structural form.

Manufacture of a component according to the invention by this process avoids the need for the use of traditional ‘prepregs’, while fully utilising current advanced composite manufacturing infrastructure. New textile technologies such as Non-Crimp-Fabrics and/or high tow count 2D weaves may be used in conjunction with the more mature ‘braiding’ technology.

Composite panel according to the invention may be manufactured for the following applications:

1) Medium size wing-to-fuselage fairing panels

2) Landing gear doors

3) Tail cones and empenage skins

4) Nacelle fan cowl doors

5) Pressure bulkheads

6) Full size fuselage panels, which would have the advantages of a design providing more cabin area, no rivets etc while being more damage tolerant.

7) Flat floor panels, with or without integral beams.

8) Large Composite ribs

The invention as hereinbefore described provides a cost effective alternative to honeycomb stiffened panels with improved damage tolerance, while maintaining the weight benefits of composites.

This is achieved through:

Innovative component design

Reduction in raw material costs (elimination of prepregs & use of new fibres, braids & non-crimp-fabrics)

Reduction in lay-up time by using thicker non-crimp-fabric plies

Removal of need for film adhesive by using resin transfer infusion

Elimination of mechanical fastening (no discrete stiffeners)

Self filling over doublers using resin transfer infusion

Resin Transfer Infusion (RTI) involves injecting resin into a mould when it is located in an autoclave. Resin is forced over the surface of the preform using low pressure Resin Transfer Mould (RTM) equipment which is facilitated through the use of a one-sided semi-flexible tool. The autoclave is used to heat and cool the mould and apply a consolidating pressure in order to quicken the ‘wet-out cycle’, remove excess resin prior to cure and minimize voids during the cure cycle.

Components according to the invention produced by Resin

Transfer Infusion give rise to the following benefits:

1. Reduced component weight due to the use of Advanced Composite Materials.

2. Low Cost Materials (use of dry fabrics with multiple layers of unidirectional fibres “stitched” together Non-crimp-fabrics (NCF) which utilise heavy weight tows)

3. Preform lay-up advantages (multiple layers of fabric can be introduced in one operation thereby reducing lay-up time

4. No Prepreg out-life concerns (large prepreg structures typically have to be laid up and cured in 10 days which dictates the Autoclave cure schedule

5. No prepregging costs (the processing, storage and expendable material cost of prepregs can be high)

6. Potentially better thickness tolerances over prepreg

7. Utilisation of existing Autoclave Composite manufacturing infrastructure

It is to be noted that it is not possible to have stiffness at right angles to the axis of the braid, though the use of triangular or trapezoidal sections will give added shear strength in structures where this is required.

This may be overcome by extra uni-directional material on the outer surfaces or braids placed on top of each other in opposite directions except half the height but full width.

As to ‘end pieces’ these could be co-injected/cured but through the use of release film removable for mandrel removal and inspection and subsequently in-jig bonded.

Multi-orientation non-crimp-fabrics would not normally be used except for ‘2D’ shapes such as fuselage skins or small local areas, picture frames or strips. This is because of their drape properties.

The use of braiding which is a reliable cost effective process will substantially reduce lay-up time.

The following are considerations which should be given in carrying out manufacture of the panels according to the invention:

1. Performing limitations; determining maximum size of panel & contour (these will vary depending on the fabric style chosen.

2. Delta Cte build up at right angles to the braid mandrels stressing the skin to braid joint, a considerable advantage which cannot be realised in novel “folded” cores.

3. Mandrel design with regard to (i) making the mandrels reusable, (ii) flexible with surface release characteristics and (iii) achieving control of Cte in three planes.

4. Determining the drape limits of the mandrels.

5. Designing a functional joint which will facilitate mandrel withdrawal, tolerate the infusion

6. Cutting of the braids and maintaining their stability at ends prior to placement into the mould.process/cured resin, is reusable and easy to operate.

7. Drape limits of fabrics, tri-axial braids and the like.

8. Wet-out of OML skin, the resin has to infuse through the inner skin and through the braid walls into the outer skin. (Braid is better than UD because it creates extra resin paths).

9. Warpage due to non-symmetrical lay-ups.

10. Mandrel removal, which will be a function of its size and shape and the amount of doubler plies.

11. NDT needs consideration but the component may be easier to inspect than a honeycomb component. Even the wall elements may be inspectable.

A major advantage of using RTI in addition to lower raw material costs and reduced lay-up time is that the expansion, due to the differential in expansion of the mandrels, during heat-up is minimised (over 57° C. instead of 154° C. in prepreg). Where this differential is needed (during cool down) to facilitate mandrel release it is maximised, over 154° C. in both cases.

Also the flexible IML mould used with RTI allows expansion normal to the surface, which is an advantage in this case. Out-life, which is a problem with prepregs, is no longer a concern with RTI.

While use of the RTI process is preferred, any process where resin is infused into the surface of a dry preform at an elevated temperature can also be considered as acceptable.

What is claimed is:

1. A fibre reinforced composite component having a front face and a rear face and a cell defining wall structure located between the front face and the rear face, characterised in that the structure has cured fibre reinforced wall elements which extend in side by side relation along the length or width of the component between the front face and the rear face and which are formed by setting up an assembly of mandrels in side by side disposition, which are clad with a reinforcing fibre material, curing the material after resin impregnation to form the wall elements, and removing the mandrels to form cells bounded or partly bounded by the wall elements.

2. A component according to claim 1 wherein the reinforcing fibre material comprises a reinforcing fibre braid applied to the mandrels prior to assembly of the mandrels.

3. A component according to claim 1 wherein the clad mandrels are arranged in spaced relation along the length or width of the component.

4. A component according to claim 1 wherein the clad mandrels are arranged in juxtaposition along the length or width of the component.

5. A component according to claim 2 wherein the assembly of clad mandrels comprises a first sub-assembly of clad mandrels extending along the length of the component and a second sub-assembly of clad mandrels superposed on the first sub-assembly of clad mandrels and extending along the width of the component.

6. A component according to claim 1 wherein the clad mandrels are of multi-sided cross-section, and the cured wall elements are formed along opposing side faces of the mandrels.

7. A component according to claim 6 wherein the clad mandrels are of rectangular or square cross-section and have two parallel opposing side faces and parallel base and top faces, and wherein the cured wall elements are formed along the parallel opposing side faces and wherein the base and top faces are at the front and rear faces of the component.

8. A component according to claim 6 wherein the clad mandrels are of triangular cross-section and have two inclined opposing side faces and a base face, and wherein the cured wall elements are formed along the inclined opposing side faces of the mandrels with the base face at the front face or the rear face of the component.

9. A component according to claim 6 wherein the clad mandrels are of trapezoidal cross-section and have two inclined opposing side faces, a base face and a top face, and wherein the cured wall elements are formed along the inclined opposing side faces of the mandrels and wherein the base and top faces are at the front and rear faces of the component.

10. A component according to claim 1 wherein the reinforcing fibre material includes a stiffener element at one or more of the side faces of the clad mandrels.

11. A component according to claim 10 wherein the clad mandrels are arranged in juxtaposition along the length of the component and wherein a stiffener element is arranged between juxtaposed clad mandrels.

12. A component according to claim 1 wherein the reinforcing fibre material includes a stiffener element at one or each of the faces of the clad mandrels at the front and/or the rear face of the component.

13. A component according to claim 1 wherein the fibre reinforcing material extends fully around the mandrels.

14. A component according to claim 1 having a front skin adjacent to the front face of the component.

15. A component according to claim 1 having a rear skin adjacent to the rear face of the component.

16. A component according to claim 1 having a front skin adjacent to the front face of the component and a rear skin adjacent to the rear face of the component wherein the front and rear skins extend along the length and width of the component and provide support for and receive support from the cured fibre reinforced wall elements.

17. A component according to claim 1 wherein the steps of resin impregnation and the curing of the impregnated material are carried out in a process in which resin is infused into the surface of a dry preform of the reinforcing fibre material at an elevated temperature.

18. A component according to claim 1 wherein the steps of resin impregnation and the curing of the impregnated material are carried out in a resin transfer infusion process.

19. A component according to claim 18, wherein the process is an elevated temperature resin transfer infusion process.

20. A method of manufacturing a fibre reinforced composite component having a front face and a rear face and a cell defining wall structure between the front face and the rear face, characterised in that the method comprises the steps of arranging a plurality of mandrels in side by side disposition and clad with a reinforcing fibre material, curing the material after resin impregnation to form from the material wall elements of the cell defining wall structure which extend in side by side relation along the width or length of the component between the front face and the rear face of the component, and removing the mandrels to form cells bounded by the wall elements.

21. A method as claimed in claim 20 wherein the mandrels are clad by applying a reinforcing fibre braid to the mandrels.

22. A method as claimed in claim 20 wherein the mandrels are arranged in spaced relation along the length or width of the component.

23. A method as claimed in claim 20 wherein the mandrels are arranged in juxtaposition along the length or width of the component.

24. A method as claimed in claim 20 wherein a first sub-assembly of clad mandrels is arranged along the length of the component, and a second sub-assembly of clad mandrels is superposed on the first sub-assembly of mandrels to extend along the width of the component.

25. A method as claimed in claim 20 wherein the component includes a front skin at the front face of the component.

26. A method as claimed in claim 25 wherein the component includes a rear skin at the rear face of the component.

27. A method according to claim 20 wherein the component includes a front skin at the front face of the component and optionally a rear skin at the rear face of the component wherein the clad mandrels and the or each of the skins are cured as an assembly after resin impregnation.

28. A method according to claim 20 wherein the steps of resin impregnation and the curing of the impregnated material are carried out in a process in which resin is infused into the surface of a dry preform of the reinforcing fibre material at an elevated temperature.

29. A method according to claim 28 wherein the fibre reinforced composite component is produced by the process without the use of pre-impregnated elements of the component.

30. A method according to claim 20 wherein the steps of resin impregnation and the curing of the impregnated material are carried out in a resin transfer infusion process.

31. A method according to claim 30 wherein the fibre reinforced composite component is produced by the process without the use of pre-impregnated elements of the component.

32. A method according to claim 30 wherein the process is an elevated temperature resin transfer infusion process.

33. A method according to claim 32 wherein the fibre reinforced composite component is produced by the process without the use of pre-impregnated elements of the component.
